(19) United States
(12) Patent Application Publication
(10) Pub. No.: US 2022/0237541 A1
(43) Pub. Date: Jul. 28, 2022

(54) System for automating a collaborative network of musicians in the field of original composition and recording

(71) Applicant: Mary Elizabeth Morkoski, New York, NY (US)

(72) Inventor: Mary Elizabeth Morkoski, New York, NY (US)

(21) Appl. No.: 17/692,314

(22) Filed: Mar. 11, 2022

Related U.S. Application Data
(60) Provisional application No. 63/138,511, filed on Jan. 17, 2021.

(51) Int. Cl. G06Q 10/06

(52) U.S. Cl. CPC G06Q 10/06311

(57) ABSTRACT

An automated system of multiple and integrated processes that connects high level and industry relevant performing artists, conductors and composers around the globe to any composers interested in original music composition and recording. The purpose of the invention is to automate the process of making and scheduling these projects and connections, thus improving the ease of scheduling, the frequency of encounters, and the equity in educational possibilities.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable

### STATEMENT REGARDING PRIOR DISCLOSURES BY THE INVENTOR OR A JOINT INVENTOR

Not applicable

### BACKGROUND OF THE INVENTION

### (1) Field of the Invention

Original Music Composition and Performance

### (2) Description of Related Art Including Information Disclosed Under 37 CFR 1.97 and 1.98

To my knowledge, there is no other site currently that is focused on automating the process of connecting artists to composers in order to educate (how to write music) and dedicated to helping the composer improve his/her skills and network in our industry. There are some that are focused on paid products, like a commercial recording release, but again not automated. For instance, there are sites where composers can hire musicians for a recording project, by the hour, to record or write together something that they have written or have in mind. These projects are recorded in recording studios and with the intention of a commercial release, and to my knowledge, it isn't education focused, but finished product focused, and managed more or less manually without much automation, if any.

SoundScore composer-clients/users are matched by an automated process with players based on the needs of their individual score (what instruments or voice types needed for the pre-written work). There is not another site that matches composers and performers according to this method and built around automation, determined by alphabet and geographical location for certain projects (see later specification and claims). For instance, the SoundScore process groups artists according to instrument types and global cities so that performers are matched with one another in similar cities for group projects. Where the city is of no concern, say for solo projects, it is based on instrument type and artists are offered work according to rotating alphabetical order and tabled order of that instrument group. Additionally, SoundScore differs from many sites as it also connects studying composers to the highest-level industry vetted performers; performers who have been carefully curated and invited by SoundScore because of their demonstrated expertise, and who are not paying a commission per project or an annual subscription fee to the SoundScore LLC.

SoundScore is primarily focused on educating any level or genre composer on best and better methods for writing for various instruments, and then editing their scores to be easier to read, in real time with them, and making archival (not commercially releasable) in home (not studio) recordings. In this sense, it might be akin to a “Masterclass” type platform, however, those courses are pre-recorded and sold to the client. Each class sold is the same and does not take the particular client's strengths, experience, personality into account. That is, there is no real and live/virtual interaction between say, Ron Howard and a client, on how to direct films, rather Ron Howard speaks to a camera in a general sense about film making and direction. SoundScore instructs but each session is personal and different and happening in real time.

But the biggest problem this SoundScore system is solving is the automation and process of making these connections available more of the time and as the need arises for any student on the globe, versus waiting for a more financially able university, or other organization, to coordinate and afford making those connections for the student.

### BRIEF SUMMARY OF THE INVENTION

An automated system of methods and processes connecting high level and industry relevant performing artists to composers and conductors around the globe. The purpose of the invention is to improve the possibility, ease and frequency of these connections by a process of automations that ultimately result in the following: to increase a composer's knowledge of writing for specific instruments as offered by recognized industry experts on said instruments; to provide feedback on score formatting for orchestral and small ensemble conducted groups; to receive archival recordings of submitted works for use in festivals, graduate programs, honors and awards, and personal websites only; and to provide networking potential, or social connectedness, for composers and performers in the field of music and live performance.

### BRIEF DESCRIPTION OF THE SEVERAL VIEWS OF THE DRAWING

FIG. 1 is the flow diagram of the beginning of every process/project of the invention—all 8 processes/projects outlined in the detailed description below.

FIG. 2 is the flow diagram for processes/projects with One on Ones

FIG. 3 is the flow diagram for processes/projects without One on Ones

FIG. 4 is the flow diagram for the ending of every process/project of the invention.

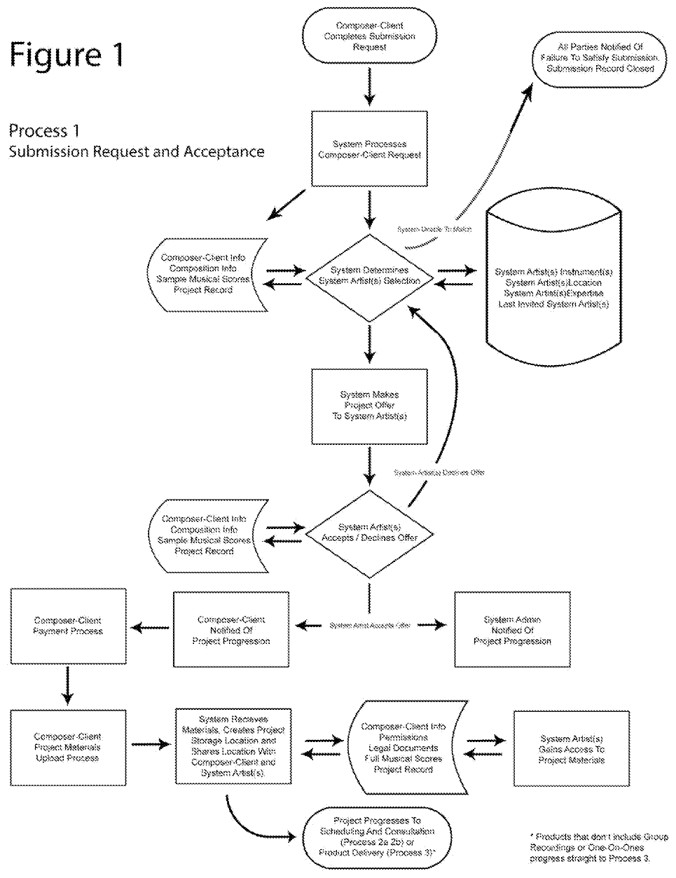

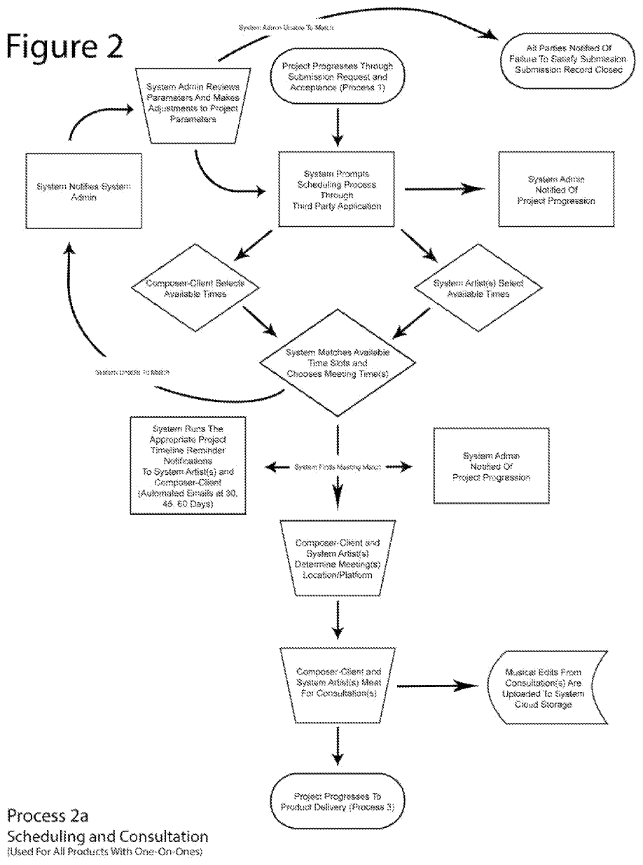

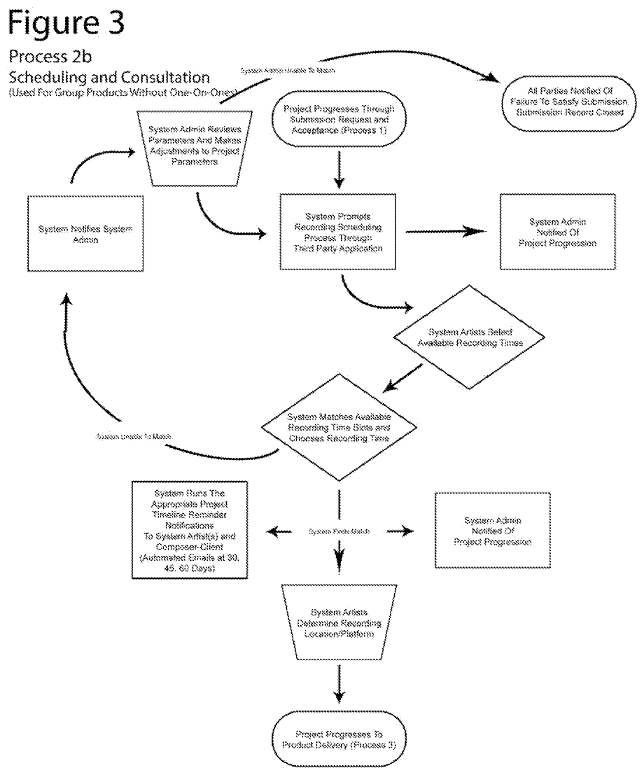

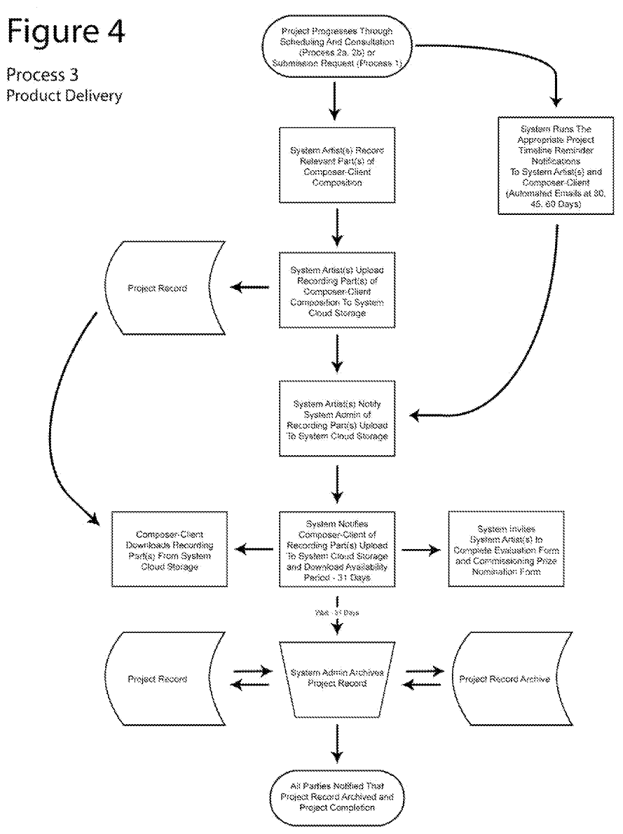

Essentially, every process/project flows either: FIG. 1, then FIG. 2, then FIG. 4. Or, the process/project flows FIG. 1, then FIG. 3, then FIG. 4.

### DETAILED DESCRIPTION OF THE INVENTION

There are 8 automated processes that the SoundScore System offers as it works to connect composer-clients to the performing musicians and conductors, they are needing for their project. It is best to describe each one. Some processes are similar in the utility functionality, so some will be grouped in the drawings. For instance, processes 1 and 2 (Ready Session Go and One on One) are similar, with the only difference being in personnel—Conductor+Client Composer versus Artist+Client Composer. The processes are the same for both.

### Process #1: Ready—Session—Go

For this process, a composer-client comes to the site and says that he/she would like to meet with a SoundScore conductor to get help preparing their original small chamber or orchestral piece for a reading or recording session. The SoundScore system asks the conducting SoundScore artist (at the present time diplomatically asked according to last name alphabetical order and rotating through the list one by one. (*I do envision, in a further embodiment that a composer-client would be able to choose performing musicians or conductors. In this case, if I lived in Europe and wanted to connect with musicians in LA because I wanted to work in Hollywood, I would request working with those musicians. But, at the current moment, the system is not built to accommodate that embodiment). An email is triggered by the SoundScore system to the conductor who is emailed that there is a request for a “Ready Session Go.” They are provided, in that same email request, a brief look at the score, uploaded and catalogued by the SoundScore system to the system's cloud storage server, and the artist is given the projected date for the completion of the project—a parameter automatically set by the process to 45 days from the date of original composer-client submission to the SoundScore system. If the conductor declines the session and the project, the SoundScore system automatically is triggered to ask the next conductor on the roster (according to next alphabetical last name), which is cataloged by the system data base (see Claim 1). The data base has every SoundScore artist catalogued according to their city, their instrument, or areas of expertise, and more information like their emails and URLS to performances and such (see Claim 1). The data base is the “brain” of SoundScore system when it comes to matching composer-clients with artists and triggering automations.

This asking process will continue to happen until a conductor accepts the project. During this matching process, the SoundScore system is built to send reminder notifications to the conducting artists and alerts that they should respond to the email ask and project within 3 days. If they fail to respond to these prompts and the project acceptance or rejection, the SoundScore system automatically triggers emails to offer the project to the next conductor (again, by alphabet according to last name). A pledge of SoundScore system is timely connections with conductors and composer-clients, and so the SoundScore system is set to ensure that automated emails are responded to and that the project moves along. (*NOTE: In the case that no conductor is available to manage the “Ready Session Go” project during the 45-day parameter, an automated email is triggered by the SoundScore system alerting the composer-client that no artist was available to meet during these dates. The composer client is kindly advised to check back in a few weeks as SoundScore conducting artist's schedules are constantly changing).

When a SoundScore conductor does accept a project, the composer-client is automatically notified by a triggered email from the SoundScore system that their project has been accepted. The composer-client is then prompted to make payment through the SoundScore website. When this is completed, the SoundScore system triggers an email and asks the composer-client to upload all files (full music scores and parts, as needed) and they are asked to provide all permissions and legal documents for signature (copyright, if necessary and using a text, agreements of “Terms of Use”, and parental forms, if under legal age to be online with a SoundScore conducting artist). These forms are collected and triggered by the SoundScore system and connected to the system's cloud storage server, and placed in a composer-client folder (ID by composer name) and shared with only the conducting artist involved. Once payment is made and files and forms are uploaded and complete, the composer-client is then prompted by the SoundScore system in a triggered email to schedule a “Ready Session Go” hour long session with the SoundScore conductor using a third-party scheduling application. The conductor and composer are scheduled through this system by mutually agreed upon times. If they forget to complete this step, the SoundScore system is built to and will continue to prompt them to schedule the session. The composer-client and SoundScore conductor are then notified by a SoundScore system triggered email of their agreed time and date, and access to the scores is granted to the conductor through the shared system's cloud storage server. Reminder emails are triggered by the SoundScore system to both conductor and composer-client at set intervals (30 days before completion deadline). An administrator of the SoundScore system is also emailed and notified if the project is not being managed on a timely basis, in order to help expedite and successfully execute any projects. Once the date and time of the “Ready Session Go” project comes and has been completed virtually on zoom or another mutually agreed upon virtual platform, both the SoundScore conductor and the composer-client are emailed an exit questionnaire about their experience. They are asked to upload that to the SoundScore cloud storage server and the SoundScore system alerts the administrator of the finished project and they are emailed copies of the questionnaire and respond as necessary. The end.

### Process #2: One on Ones

For this process, a composer-client comes to the site and says that he/she would like to meet with a SoundScore artist to get help preparing their original work/piece. The composer client in this sense is looking to gain intimate knowledge of how a particular instrument or voice type works best. The SoundScore artists are experts in their field and know correct fingerings, correct octaves and placements for things to sound the way a composer envisions them, and best ways to execute. This is the information the composer-client is after in these sessions, plus the opportunity to meet important and relevant performing artists on that particular instrument or voice type.

The SoundScore system asks the SoundScore artist, based on their instrument or voice type, if they are interested in having a one on one session (at the present time diplomatically asked according to last name alphabetical order and rotating through the list one by one. (*I do envision, in a further embodiment that a composer-client would be able to choose performing musicians or conductors. In this case, if I lived in Europe and wanted to connect with musicians in LA because I wanted to work in Hollywood, I would request working with those musicians. But, at the current moment, the system is not built to accommodate that embodiment). An email is triggered by the SoundScore system to the artist who is emailed that there is a request for a “One on One.” They are provided, in that same email request, a brief look at the score, uploaded and catalogued by the SoundScore system to a cloud storage server, the artist is given the projected date for the completion of the project—a parameter automatically set by the process to 45 days from the date of original composer-client submission to the SoundScore system. If the artist declines the session and the project, the SoundScore system automatically is triggered to ask the next artist in that instrument or voice type category on the roster (according to next alphabetical last name), which is cataloged by the system data base (see Claim 1). The data base has every SoundScore artist catalogued according to their city, their instrument, or areas of expertise, and more information like their emails and URLS to performances and such (see Claim 1). The data base is the “brain” of SoundScore system when it comes to matching composer-clients with artists and conductors and triggering automations.

This asking process will continue to happen until an artist accepts the project. During this matching process, the SoundScore system is built to send reminder notifications to the artists and alerts that they should respond to the email ask and project within 3 days. If they fail to respond to these prompts and the project acceptance or rejection, the SoundScore system automatically triggers emails to offer the project to the next instrument or voice specific artist needed (again, by alphabet according to last name in the data base). A pledge of SoundScore system is timely connections with artists and composer-clients, and so the SoundScore system is set to ensure that automated emails are responded to and that the project moves along. (*NOTE: In the case that no artist is available to manage the “One on One” project during the 45 day parameter, an automated email is triggered by the SoundScore system alerting the composer-client that no artist was available to meet during these dates. The composer client is kindly advised to check back in a few weeks as artist's schedules are constantly changing).

When a SoundScore artist does accept a project, the composer-client is automatically notified by a triggered email from the SoundScore system that their project has been accepted. The composer-client is then prompted to make payment through the SoundScore website. When this is completed, the SoundScore system triggers an email and asks the composer-client to upload all files (full music scores and parts, as needed) and they are asked to provide all permissions and legal documents for signature (copyright, if necessary and using a text, agreements of “Terms of Use”, and parental forms, if under legal age to be online with a SoundScore artist). These forms are collected and triggered by the SoundScore system and connected to the system's cloud storage server, and placed in a composer-client folder (ID by composer name) and shared with only the artist involved. Once payment is made and files and forms are uploaded and complete, the composer-client is then prompted by the SoundScore system in a triggered email to schedule a “One on One” hour long session with the SoundScore artist using a third-party scheduling application. The artist and composer are scheduled through this system by mutually agreed 1U upon times. If they forget to complete this step, the SoundScore system is built to and will continue to prompt them to schedule the session. The composer-client and SoundScore artist are then notified by a SoundScore system triggered email of their agreed time and date, and access to the scores is granted to the artist through the shared cloud file folder (also triggered by SoundScore system). Reminder emails are triggered by the SoundScore system to both artist and composer-client at set intervals (30 days before completion deadline). An administrator of the SoundScore system is also emailed and notified if the project is not being managed on a timely basis, in order to help expedite and successfully execute any projects. Once the date and time of the “One on One” project comes and has been completed virtually on zoom or another mutually agreed upon virtual platform, both the SoundScore artist and the composer-client are emailed an exit questionnaire about their experience. They are asked to upload that to the SoundScore cloud storage server and the SoundScore system alerts the administrator of the finished project and they are emailed copies of the questionnaire and respond as necessary. The end.

There are 6 more processes left. These are recording packages WITH one on one sessions and recording packages ONLY (that is, without the one on ones) in both solo and ensemble formats. These processes are:
A. Solo recording package with one one one session
B. Solo recording package without one on one session
C. Group “IN PERSON” recording packages with one on one sessions
D. Group “IN PERSON” recording package without one on one sessions
E. Group “Distanced” recording packages with one on one sessions
F. Group “Distanced” recording packages without one one one sessions
   Process #3: Solo Recording with One on One Session

For this process, a composer-client comes to the site and says that he/she would like to have the service for a solo recording package with a one one one session. The composer client in this sense is looking to gain intimate knowledge of how a particular instrument or voice type works best, to have a good edit of their score in the one on one session, and then have a fully edited score and a reading recording (for archival purposes only) as an end product. The SoundScore artists are experts in their field and know correct fingerings, correct octaves and placements for things to sound the way a composer envisions them, and best ways to execute. This is the information the composer-client is after in these sessions, plus the opportunity to meet important and relevant performing artists on that particular instrument or voice type. And, finally to have a recording of their work made by an artist well versed in recording techniques and also on their instrument is invaluable to a growing or emerging (or even established) composer.

The SoundScore system asks the SoundScore solo artist if they are interested in a recording project plus the one on one session—at the present time diplomatically asked according to last name alphabetical order and rotating through the list one by one. (*I do envision, in a further embodiment that a composer-client would be able to choose performing musicians or conductors. In this case, if I lived in Europe and wanted to connect with musicians in LA because I wanted to work in Hollywood, I would request working with those musicians). An email is triggered by the SoundScore system to the artist who is emailed that there is a request for a “Solo recording package with a One on One session.” They are provided, in that same email request, a brief look at the score (uploaded and catalogued by the SoundScore system cloud storage server) and the artist is given the projected date for the completion of the project—a parameter automatically set by this specific process to 90 days from the date of original composer-client submission to the SoundScore system. If the artist declines the project, the SoundScore system automatically is triggered to ask the next artist in that instrument or voice type category on the roster, again according to next alphabetical last name, and cataloged by the SoundScore system's data base (see claim 1). The system's data base has every SoundScore artist catalogued according to their city, their instrument, or areas of expertise, and more information like their emails and URLS to performances and such. This data base is the “brain” of the SoundScore system when it comes to matching composer-clients with artists and triggering emails and requests.

This asking process will continue to happen until an artist accepts the project. During this matching process, the SoundScore system is built to send reminder notifications to the artists and alerts that they should respond to the email ask and project within 3 days. If they fail to respond to these prompts and the project acceptance or rejection, the SoundScore system automatically triggers emails to offer the project to the next instrument or voice specific artist needed (again, by alphabet according to last name). A pledge of SoundScore system is timely connections with artists and composer-clients, and so the SoundScore system is set to ensure that automated emails are responded to and that the project moves along. (*NOTE: In the case that no artist is available to manage the project during the 90-day parameter, an automated email is triggered by the SoundScore system alerting the composer-client that no artist was available to meet during these dates. The composer client is kindly advised to check back in a few weeks as artist's schedules are constantly changing).

When a SoundScore artist does accept the project, the composer-client is automatically notified by a triggered email from the SoundScore system that their project has been accepted. The composer-client is then prompted to make payment through the SoundScore system. When this is completed, the SoundScore system triggers an email and asks the composer-client to upload all files (full music scores and parts, as needed) and they are asked to provide all permissions and legal documents for signature (copyright, if necessary and using a text, agreements of “Terms of Use”, and parental forms, if under legal age to be online with a SoundScore artist). These forms are collected and triggered by the SoundScore system, and placed in a composer-client folder (ID by composer name) and shared with only the artist involved on the system's cloud storage server. Once payment is made and files and forms are uploaded and complete, the composer-client is then prompted by the SoundScore system in a triggered email to schedule a “One on One” hour long session with the SoundScore artist using a third-party scheduling application. The artist and composer are scheduled through this system by mutually agreed upon times and the process is automated and set for the first 45 days of the overall 90 for the project. Reason: The composer-client and the artist need to meet to go over the score and edit and work, prior to the recording. The recording can happen, and is set in the process, for automatically scheduling in the last 45 days of the overall 90. If they forget to complete this step, the SoundScore system is built to and will continue to prompt them to schedule the session. The composer-client and SoundScore artist are then notified by a SoundScore system triggered email of their agreed time and date, and access to the scores is granted to the artist through the shared cloud storage server (also automated and triggered by SoundScore system). A reminder email is automatically triggered by the SoundScore system to both artist and composer-client at 30 days of this overall 90 to ensure the One on One happens before the 45 days have elapsed. An administrator of the SoundScore system is also emailed and notified if the project is not being managed on a timely basis, in order to help expedite and successfully execute any projects. Once the date and time of the “One on One” project comes and has been completed virtually on zoom or another mutually agreed upon virtual platform, both the SoundScore artist and the composer-client are reminded by the SoundScore system that they have a project to be completed by “x” date. This reminder is automatically triggered by the SoundScore system at 45 days. As this is a solo recording, the time for that recording is very flexible and unscheduled, since it only involves one person's time and calendar (the composer is not part of the recording session). It just has to be completed before the 90-day completion date. The SoundScore system is automatically triggering reminder emails to the artist at Day 72 and again at Day 83 about the completion deadline date. The SoundScore administrative team is also receiving these notifications automatically to ensure timely submission and completion of the project. Once the recording is made, the artist uploads the recorded files to the shared cloud storage server and ID folder, and the composer-client is automatically notified of the recording files for retrieval. There is an automation of date of deletion of data in these files (for storage allowance purposes) of one month beyond the completion of the project end date.

Both the recording artist and the composer-client are automatically emailed an exit questionnaire about their experience. They are asked to upload that to the SoundScore platform and the SoundScore system alerts the administrator of the finished project and they are emailed copies of the questionnaire and responds as necessary. The end.

Process #4: Solo Recording without One on One Session

For this process, a composer-client comes to the site and says that he/she would like to have the service for a solo recording package only (without a one one one session). The composer client in this sense is looking to have a recording of their work made by an artist well versed in recording techniques and also a recognized industry expert on their instrument. A good quality recording is invaluable to a growing or emerging (or even established) composer's life in professional music.

The SoundScore system asks the SoundScore solo artist if they are interested in a recording project, at the present time diplomatically asked according to last name alphabetical order and rotating through the list one by one. (*I do envision, in a further embodiment that a composer-client would be able to choose their performing artists and conductors. In this case, if I lived in Europe and wanted to connect with musicians in LA because I wanted to work in Hollywood, I would request working with those musicians). An email is triggered by the SoundScore system to the artist who is emailed that there is a request for a “Solo recording package only.” They are provided, in that same email request, a brief look at the score (uploaded by the system's cloud storage server) and the artist is given the projected date for the completion of the project—a parameter automatically set by the SoundScore system to 90 days for this project from the date of original composer-client submission to the SoundScore system. If the artist declines the project, the SoundScore system automatically is triggered to ask the next artist in that instrument or voice type category on the roster (according to next alphabetical last name), which is cataloged by the system's data base. The SoundScore data base has every artist catalogued according to their city, their instrument, or areas of expertise, and more information like their emails and URLS to performances and such. This data base is the “brain” of SoundScore system when it comes to matching composer-clients with artists and triggering.

This asking process will continue to happen until an artist accepts the project. During this matching process, the SoundScore system is built to send reminder notifications to the artists and alerts that they should respond to the email ask and project within 3 days. If they fail to respond to these prompts and the project acceptance or rejection, the SoundScore system automatically triggers emails to offer the project to the next instrument or voice specific artist needed (again, by alphabet according to last name). A pledge of SoundScore system is timely connections with artists and composer-clients, and so the SoundScore system is set to ensure that automated emails are responded to and that the project moves along. (*NOTE: In the case that no artist is available to manage the project during the 90-day parameter, an automated email is triggered by the SoundScore system alerting the composer-client that no artist was available during these dates. The composer client is kindly advised to check back in a few weeks as artist's schedules are constantly changing).

When a SoundScore artist does accept the project, the composer-client is automatically notified by a triggered email from the SoundScore system that their project has been accepted. The composer-client is then prompted to make payment through the SoundScore website. When this is completed, the SoundScore system triggers an email and asks the composer-client to upload all files (full music scores and parts, as needed) and they are asked to provide all permissions and legal documents for signature (copyright, if necessary and using a text, agreements of “Terms of Use”, and parental forms, if under legal age to be online with a SoundScore artist). These forms are collected and triggered by the SoundScore system and connected to the system's cloud storage server, and placed in a composer-client folder (ID by composer name) and shared with only the artist involved. Once payment is made and files and forms are uploaded and complete, the composer-client is notified by the SoundScore system. The composer-client and SoundScore artist are then notified by a SoundScore system triggered email of the agreed deadline for completion date, and access to the scores is granted to the solo artist through the shared file folder. An automatic email is triggered at Day 45 of the overall 90 by the SoundScore system to the solo artist reminding them of the project's complete by “x” date. As this is a solo recording, the time for them to record is very flexible and unscheduled (since it only involves one person's calendar). It just has to be completed before the 90-day completion date. Additionally, the SoundScore system is automatically triggering reminder emails to the artist at Day 72 and again at Day 83 about the completion deadline date. The SoundScore administrative team is also receiving these notifications automatically to ensure timely submission and completion of the project. Once the recording is made, the solo artist uploads the recorded files to the shared ID folder, and the composer-client is automatically notified of the recording files available for retrieval. There is an automatic date of deletion of these files (for storage purposes) of one month beyond the project's completion date.

Both the recording artist and the composer-client are automatically emailed an exit questionnaire about their experience. They are asked to upload that to the SoundScore platform and the SoundScore system alerts the administrator of the finished project and they are emailed copies of the questionnaire and responds as necessary. The end.

Process #5: In-Person Group Recording with Multiple One on One Sessions

For this process, a composer-client comes to the site and says that he/she would like to have the service for an “In-Person” recording package with multiple one on one sessions with all artists involved. The composer client in this sense is looking to gain intimate knowledge of how particular instruments or voice types work best; to have good edits of their score and parts as a result of the one on one sessions, and then have a fully edited score and parts plus a reading recording (for archival purposes only) as an end product. The SoundScore artists are experts in their field and know correct fingerings, correct octaves and placements for things to sound the way a composer envisions them, and best ways to execute. They can make suggestions for all of these things and composers need this real time response to what they have written. This is the information the composer-client is after in the one on one sessions, plus the opportunity to meet important and relevant performing artists on that particular instrument or voice type; and, finally to have a recording of their work made by artists well versed in recording techniques and also on their instruments is invaluable to a growing or emerging (or even established) composer.

First, the SoundScore system identifies, by way of the composer application on the platform, what instruments are needed for this project. As it is an “In Person” group recording, the system searches Airtable to find the artists for the instrumentation needed and those artists need to be in the same city. The artists are listed by tables according to city groupings and instrument groupings (see Claim 1). When the SoundScore system identifies the artists, it automatically asks the SoundScore artists if they are interested in a recording project plus the one on one sessions, and this is done by alphabetical order on instruments in a city and rotating through that list one by one. (*I do envision, in a further embodiment that a composer-client would be able to personally choose performing musicians or conductors. In this case, if I lived in Europe and wanted to connect with musicians in LA because I wanted to work in Hollywood, I would request working with those musicians). An email is triggered by the SoundScore system to the necessary artists (2 to 8 in number) who are emailed that there is a request for an “In person group recording package plus One on One sessions.” The artists involved are provided, in that same email request, a brief look at the score and parts, uploaded and catalogued by the SoundScore system cloud storage server, and the artists are given the projected date for completion of the recording project—a parameter automatically set by the process to 90 days from the date of original composer-client application submission to the SoundScore system. If any of the necessary artists decline the project, the SoundScore system is automatically triggered to ask the next artist in that instrument or voice type category on the roster (according to next alphabetical last name), and cataloged by the system's data base. The data base has every SoundScore artist catalogued according to their city, their instrument, or areas of expertise, and more information like their emails and URLS to performances and such (see Claim 1). This data base is the “brain” of SoundScore system when it comes to matching composer-clients with artists and triggering.

This asking process will continue to happen until all needed artists for the project accept the project. During this matching process, the SoundScore system is built to send reminder notifications to the artists and alerts that they should respond to the email ask and project within 3 days. If they fail to respond to these prompts and the project acceptance or rejection, the SoundScore system automatically triggers emails to offer the project to the next instrument or voice specific artist needed (again, by alphabet according to last name). A pledge of SoundScore system is timely connections with artists and composer-clients, and so the SoundScore system is built to ensure that automated emails are responded to and that the project moves along. (*NOTE: In the case that the artists needed are not available to manage the project during the 90-day parameter, an automated email is triggered by the SoundScore system alerting the composer-client that the artists were not available to meet during the projected date. The composer client is kindly advised to check back in a few weeks as artist's schedules are constantly changing).

When all needed SoundScore artists accept the project, the composer-client is automatically notified by a triggered email from the SoundScore system that their project has been accepted. The composer-client is then prompted to make payment through the SoundScore website. When this is completed, the SoundScore system triggers an email and asks the composer-client to upload all files (full music scores and parts, as needed) and they are asked to provide all permissions and legal documents for signature (copyright, if necessary and using a text, agreements of “Terms of Use”, and parental forms, if under legal age to be online with SoundScore artists). These forms are collected and triggered by the SoundScore system and connected to a SoundScore system cloud storage server, and placed in a composer-client folder (ID by composer name) and shared only with the artists involved. Once payment is made and files and forms are uploaded and complete, the composer-client is then prompted by the SoundScore system in a triggered email to schedule their “One on One” hour long sessions with each SoundScore artist involved on the project using a third-party scheduling application. The artists and composer are scheduled through this system by mutually agreed upon times and this part of the project and process, completion of the One on Ones, is set during the first 45 days of the overall 90 for the project. Reason: The composer-client and the artists need to meet to go over the score and edit and work, prior to the “In Person group recording” session. The recording is automated in the SoundScore system for scheduling in the last 45 days of the overall 90. If any involved in the One on Ones forgot to complete this step, the SoundScore system is built to and will continue to prompt them to schedule the session. The composer-client and SoundScore artists are then notified by a SoundScore system triggered email of their agreed times and dates, and access to the scores is granted to the artists through the shared ID file folder (also triggered by SoundScore system). A reminder email is automatically triggered by the SoundScore system to all artists involved and the composer-client at 30 days of this overall 90 to ensure the One on Ones happen before the 45 days have elapsed. An administrator of the SoundScore system is also emailed and notified if the project is not being managed on a timely basis, in order to help expedite and successfully execute any projects. Once the date and time of the “One on One” part of the project comes and has been completed virtually on zoom or another mutually agreed upon virtual platform, both the SoundScore artists and the composer-client are reminded by the SoundScore system that they have a project to be completed by “x” date. This reminder is automatically triggered by the SoundScore system at 45 days. As this is a group recording, the SoundScore system is built to trigger an automated email for the scheduling of the recording session between the artists. This process is automatically triggered by the system and uses a third-party scheduling application.

The SoundScore system is automatically triggering reminder emails to the artists at Day 72 and again at Day 83 about the completion deadline date. The SoundScore administrative team is also receiving these notifications automatically to ensure timely submission and completion of the project. Once the recording is made, the artists upload the recorded files to the shared ID folder on the system's cloud storage server, and the composer-client is automatically notified of the recording files for retrieval. There is an automatic date of deletion of these files (for storage purposes) of one month beyond the completion of the project's end date.

All of the recording artists involved and the composer-client are automatically emailed an exit questionnaire about their experience. They are asked to upload that to the SoundScore platform and the SoundScore system alerts the administrator of the finished project and they are emailed copies of the questionnaire and responds as necessary. The end.

Process #6: In-Person Group Recording without One on One Sessions

For this process, a composer-client comes to the site and says that he/she would like to have the service for an “In-Person” recording package only, that is without multiple one on one sessions. The composer client in this sense is looking to obtain a high-quality recording of their work made by artists well versed in recording techniques and recognized industry experts on their instruments. A good quality recording is invaluable to a growing or emerging (or even established) composer's life in professional music.

First, the SoundScore system identifies, by way of the composer application on the platform, what instruments are needed for this project. As it is an “In Person” group recording, the system's data base (see Claim 1) to find the artists for the instrumentation needed and those artists need to be in the same city. The artists are listed by city groupings and instrument groupings. When the SoundScore system identifies the artists, it automatically asks the SoundScore artists if they are interested in a recording project, and this is done by alphabetical order on instruments in a city and rotating through that list one by one. (*I do envision, in a further embodiment that a composer-client would be able to personally choose performing musicians or conductors. In this case, if I lived in Europe and wanted to connect with musicians in LA because I wanted to work in Hollywood, I would request working with those musicians). An email is triggered by the SoundScore system to the necessary artists (2 to 8 in number) who are emailed that there is a request for an “In person” group recording package only. The artists involved are provided, in that same email request, a brief look at the score and parts (uploaded and catalogued by the SoundScore system's cloud storage server and the artists are given the projected date for completion of the project—a parameter automatically set by the process to 90 days from the date of original composer-client application submission to the SoundScore system. If any of the necessary artists decline the project, the SoundScore system automatically is triggered to ask the next artist in that instrument or voice type category on the roster (according to next alphabetical last name), and cataloged by the system's data base. This data base has every SoundScore artist catalogued according to their city, their instrument, or areas of expertise, and more information like their emails and URLS to performances and such (see Claim 1). This data base is the “brain” of SoundScore system when it comes to matching composer-clients with artists and triggering.

This asking process will continue to happen until all needed artists accept the project. During this matching process, the SoundScore system is built to send reminder notifications to the artists and alerts that they should respond to the email ask and project within 3 days. If they fail to respond to these prompts and the project acceptance or rejection, the SoundScore system automatically triggers emails to offer the project to the next instrument or voice specific artist needed (again, by alphabet according to last name). A pledge of SoundScore system is timely connections with artists and composer-clients, and so the SoundScore system is built to ensure that automated emails are responded to and that the project moves along. (*NOTE: In the case that the artists needed are not available to manage the project during the 90-day parameter, an automated email is triggered by the SoundScore system alerting the composer-client that the artists were not available during the projected date. The composer client is kindly advised to check back in a few weeks as artist's schedules are constantly changing).

When all needed SoundScore artists accept the project, the composer-client is automatically notified by a triggered email from the SoundScore system that their project has been accepted. The composer-client is then prompted to make payment through the SoundScore website. When this is completed, the SoundScore system triggers an email and asks the composer-client to upload all files (full music scores and parts, as needed) and they are asked to provide all permissions and legal documents for signature (copyright, if necessary and using a text, agreements of “Terms of Use”, and parental forms, if under legal age to be online with SoundScore artists). These forms are collected and triggered by the SoundScore system and stored on the system's cloud storage server, and placed in a composer-client folder (ID by composer name) and shared only with the artists involved. Once payment is made and files and forms are uploaded and complete, the composer-client and SoundScore artists are then notified by a SoundScore system triggered email of the agreed deadline for completion date, and access to the scores is granted to all artists involved through the shared ID file folder (also triggered by SoundScore system).

A reminder email is automatically triggered by the SoundScore system at 45 days. As this is a group recording, the SoundScore system is built to trigger the scheduling of the recording session between the artists. This process is automatically triggered by the system and uses a third-party scheduling application. The artists receive that notification and, using the third-party application, find a mutually agreeable time to make the “In Person” group recording.

The SoundScore system is automatically triggering reminder emails to the artists at Day 72 and again at Day 83 about the completion deadline date. The SoundScore administrative team is also receiving these notifications automatically to ensure timely submission and completion of the project. Once the recording is made, the artists upload the recorded files to the shared ID folder, and the composer-client is automatically notified of the recording files for retrieval. There is an automatic date of deletion of these files (for storage purposes) of one month beyond the completion of the project's end date.

All of the recording artists involved and the composer-client are automatically emailed an exit questionnaire about their experience. They are asked to upload that to the SoundScore platform and the SoundScore system alerts the administrator of the finished project and they are emailed copies of the questionnaire and responds as necessary. The end.

Process #7: Group “Distanced” Recording Package with One One One Sessions

For this process, a composer-client comes to the site and says that he/she would like to have the service for an “Distanced” recording package with multiple one on one sessions with all artists involved. The composer client in this sense is looking to gain intimate knowledge of how particular instruments or voice types work best; to have good edits of their score and parts as a result of the one on one sessions, and then have a fully edited score and parts plus a reading recording (for archival purposes only) as an end product. The SoundScore artists are experts in their field and know correct fingerings, correct octaves and placements for things to sound the way a composer envisions them, and best ways to execute. They can make suggestions for all of these things and composers need this real time response to what they have written. This is the information the composer-client is after in the one on one sessions, plus the opportunity to meet important and relevant performing artists on that particular instrument or voice type; and, finally to have a recording of their work made by artists well versed in recording techniques and also on their instruments is invaluable to a growing or emerging (or even established) composer.

First, the SoundScore system identifies, by way of the composer application on the platform, what instruments are needed for this project. As it is an “Distanced” Group Recording, the system searches the system's data base (see Claim 1) to find the artists for the instrumentation needed and those artists need NOT be in the same city. The artists are listed by city groupings and instrument groupings. The same artists are also listed on a virtual city, called SoundScore City, so that projects do not have to be limited to “in person” availability of all artists needed to satisfy the needs of the project and recording. When the SoundScore system identifies the artists, it automatically asks the SoundScore artists if they are interested in a recording project plus the one on one session, again this is done by alphabetical order on instruments in a city and rotating through that list one by one. (*I do envision, in a further embodiment that a composer-client would be able to personally choose performing musicians or conductors. In this case, if I lived in Europe and wanted to connect with musicians in LA because I wanted to work in Hollywood, I would request working with those musicians). An email is triggered by the SoundScore system to the necessary artists (2 to 8 in number) who are emailed that there is a request for a “Distanced” group recording package plus One on One sessions. The artists involved are provided, in that same email request, a brief look at the score and parts, uploaded and catalogued by the SoundScore system's cloud storage server, and the artists are given the projected date for completion of the project—a parameter automatically set by the process to 90 days from the date of original composer-client application submission to the SoundScore system. If any of the necessary artists decline the project, the SoundScore system automatically is triggered to ask the next artist on that instrument or voice type category on the roster (according to next alphabetical last name) and NOT limited by geographic location, and cataloged by the system's data base. This data base has every SoundScore artist catalogued according to their city, SoundScore city, their instrument, or areas of expertise, and more information like their emails and URLS to performances and such (see Claim 1). This data base is the “brain” of SoundScore system when it comes to matching composer-clients with artists and triggering.

This asking process will continue to happen until all needed artists accept the project. During this matching process, the SoundScore system is built to send reminder notifications to the artists and alerts that they should respond to the email ask and project within 3 days. If they fail to respond to these prompts and the project acceptance or rejection, the SoundScore system automatically triggers emails to offer the project to the next instrument or voice specific artist needed (again, by alphabet according to last name). A pledge of SoundScore system is timely connections with artists and composer-clients, and so the SoundScore system is built to ensure that automated emails are responded to and that the project moves along. (*NOTE: In the case that the artists needed are not available to manage the project during the 90-day parameter, an automated email is triggered by the SoundScore system alerting the composer-client that the artists needed were not available to meet during the projected date. The composer client is kindly advised to check back in a few weeks as artist's schedules are constantly changing).

When all needed SoundScore artists accept the project, the composer-client is automatically notified by a triggered email from the SoundScore system that their project has been accepted. The composer-client is then prompted to make payment through the SoundScore website. When this is completed, the SoundScore system triggers an email and asks the composer-client to upload all files (full music scores and parts, as needed), and they are asked to provide all permissions and legal documents for signature (copyright, if necessary and using a text, agreements of “Terms of Use”, and parental forms, if under legal age to be online with SoundScore artists). These forms are collected and triggered by the SoundScore system and connected to the system's cloud storage server, and placed in a composer-client folder (ID by composer name) and shared only with the artists involved. Once payment is made and files and forms are uploaded and complete, the composer-client is then prompted by the SoundScore system in a triggered email to schedule their “One on One” hour long sessions with each SoundScore artist involved on the project using a third-party scheduling application. The artists and composer are scheduled through this system by mutually agreed upon times and this part of the project and process. Completion of the One on Ones, is set during the first 45 days of the overall 90 for the project. Reason: The composer-client and the artists need to meet to go over the score and edit and work, prior to the “Distanced” group recording's start. The recording is built in the process for completion in the last 45 days of the overall 90. If they forget to complete this step, the SoundScore system is built to and will continue to prompt them to schedule the session. The composer-client and SoundScore artists are then notified by a SoundScore system triggered email of their agreed time and date, and access to the scores is granted to the artists involved through the shared ID file folder (also triggered by SoundScore system). A reminder email is automatically triggered by the SoundScore system to all artists involved and the composer-client at 30 days of this overall 90 to ensure the One on Ones happen before the 45 days have elapsed. An administrator of the SoundScore system is also emailed and notified if the project is not being managed on a timely basis, in order to help expedite and successfully execute any projects. Once the date and time of the “One on One” part of the project comes and has been completed virtually on zoom or another mutually agreed upon virtual platform (45 days), both the SoundScore artists and the composer-client are reminded by the SoundScore system that they have a project to be completed by “x” date. This reminder is automatically triggered by the SoundScore system at 45 days.

As this is a “distanced” group recording, there is no need to schedule a mutual time between the artists. They will be recording alone and uploading their parts to the shared ID file folder. (*Note: On some projects there may be a suggested order for recording document in the shared ID file folder and artists involved are reminded to take a look at that “suggested order for recording.”) The SoundScore system sends them a notification at 45 days reminding them to upload all files in a manner that allows timely completion of the recording project.

The SoundScore system is automatically triggering reminder emails to the artists at Day 72 and again at Day 83 about the completion deadline date. The SoundScore administrative team is also receiving these notifications automatically to ensure timely submission and completion of the project.

Once all of the recording tracks are made and the artists have upload the recorded files to the shared ID file folder, the composer-client is automatically notified of the recording files for retrieval. There is an automatic date of deletion of these files (for storage purposes) of one month beyond the completion of the project end date. It is expected that the composer, or a chosen audio engineer, will edit and sync the independently recorded audio files together post recording.

All of the recording artists involved and the composer-client are automatically emailed an exit questionnaire about their experience. They are asked to upload that to the SoundScore platform and the SoundScore system alerts the administrator of the finished project and they are emailed copies of the questionnaire and responds as necessary. The end.

### Process #8: Group “Distanced” Recording Package Only

For this process, a composer-client comes to the site and says that he/she would like to have the service for a “Distanced” recording package only without click track, and without multiple one on one sessions. The composer client in this sense is looking to obtain a high-quality recording of their work made by artists well versed in recording techniques and recognized industry experts on their instruments. A good quality recording is invaluable to a growing or emerging (or even established) composer's life in professional music.

First, the SoundScore system identifies, by way of the composer application on the platform, what instruments are needed for this project. As it is a “Distanced” group recording, the system searches the data base (see Claim 1) to find the artists for the instrumentation needed and those artists need NOT be in the same city. The artists are listed by city groupings and instrument groupings. The same artists are also listed on a virtual city, called SoundScore City, so that projects do not have to be limited to “in person” availability of all artists needed to satisfy the needs of any project and recording. When the SoundScore system identifies the artists, it automatically asks the SoundScore artists if they are interested in a recording project, and this is done by alphabetical order on instruments and rotating through that list one by one. (*I do envision, in a further embodiment that a composer-client would be able to personally choose performing musicians or conductors. In this case, if I lived in Europe and wanted to connect with musicians in LA because I wanted to work in Hollywood, I would request working with those musicians). An email is triggered by the SoundScore system to the necessary artists (2 to 8 in number) who are emailed that there is a request for a “Distanced” group recording package. The artists involved are provided, in that same email request, a brief look at the score and parts uploaded and catalogued by the SoundScore system's cloud storage server, and the artists are given the projected date for completion of the project—a parameter automatically set by the process to 90 days from the date of original composer-client application submission to the SoundScore system. If any of the necessary artists decline the project, the SoundScore system automatically is triggered to ask the next artist in that instrument or voice type category on the roster (according to next alphabetical last name), and cataloged by the system's data base (see Claim 1). This data base has every SoundScore artist catalogued according to their city, virtual SoundScore city, their instrument, or areas of expertise, and more information like their emails and URLS to performances and such. This data base is the “brain” of SoundScore system when it comes to matching composer-clients with artists and triggering.

This asking process will continue to happen until all needed artists accept the project. During this matching process, the SoundScore system is built to send reminder notifications to the artists and alerts that they should respond to the email ask and project within 3 days. If they fail to respond to these prompts and the project acceptance or rejection, the SoundScore system automatically triggers emails to offer the project to the next instrument or voice specific artist needed (again, by alphabet according to last name). A pledge of SoundScore system is timely connections with artists and composer-clients, and so the SoundScore system is built to ensure that automated emails are responded to and that the project moves along. (*NOTE: In the case that the artists needed are not available to manage the project during the 90-day parameter, an automated email is triggered by the SoundScore system alerting the composer-client that the artists were not available to meet during the projected date. The composer client is kindly advised to check back in a few weeks as artist's schedules are constantly changing).

When all needed SoundScore artists accept the project, the composer-client is automatically notified by a triggered email from the SoundScore system that their project has been accepted. The composer-client is then prompted to make payment through the SoundScore website. When this is completed, the SoundScore system triggers an email and asks the composer-client to upload all files (full music scores and parts, as needed) and they are asked to provide all permissions and legal documents for signature (copyright, if necessary and using a text, agreements of “Terms of Use”, and parental forms, if under legal age to be online with SoundScore artists). These forms are collected and triggered by the SoundScore system and connected to a SoundScore cloud storage server, and placed in a composer-client folder (ID by composer name) and shared only with the artists involved. Once payment is made and files and forms are uploaded and complete, the composer-client and SoundScore artists are then notified by a SoundScore system triggered email of the agreed deadline for completion date, and access to the scores is granted to all artists involved through the shared ID file folder (also triggered by SoundScore system).

A reminder email is automatically triggered by the SoundScore system at 45 days. As this is a “distanced” group recording, there is no need to schedule a mutual time between the artists. They will be recording alone and uploading their parts to the shared Dropbox file. (*Note: On some projects there may be a suggested order for recording document in the shared ID file folder and artists involved are reminded to take a look at that “suggested order for recording.”) The SoundScore system sends them a notification at 45 days reminding them to upload files in a manner that allows timely completion of the recording project.

The SoundScore system is automatically triggering reminder emails to the artists at Day 72 and again at Day 83 about the completion deadline date. The SoundScore administrative team is also receiving these notifications automatically to ensure timely submission and completion of the project.

Once all of the recording tracks are made and the artists have uploaded the recorded files to the shared ID file folder, the composer-client is automatically notified of the recording files for retrieval. There is an automatic date of deletion of these files (for storage purposes) of one month beyond the completion of the project's end date. It is expected that the composer, or a chosen audio engineer, will edit and sync the independent files together post recording.

All of the recording artists involved and the composer-client are automatically emailed an exit questionnaire about their experience. They are asked to upload that to the SoundScore platform and the SoundScore system alerts the administrator of the finished project and they are emailed copies of the questionnaire and responds as necessary. The end.

1. A music education and recording network of composers and performers organized and connected to client-composers based on specifics of client-composer's work by a process of automated operations performed by a system comprising;
A table/listing of every artist by geographic location, the table/listing according to closest metropolitan area to said artist's home location;
A table/listing of every artist by instrument category, the table/listing of complete catalogues of instruments available to each said artist;
A table/listing of every artist by virtual geographic location, the table/listing being an imaginary or cloud based, non-site specific point on the globe.

2. An automated music recording and education system (blah) that is limited to 90 or 45 day periods depending on the project request.

3. The system of claim 1 or claim 2, wherein the system asks for, recognizes, and then searches the specifications for projects from client-composers, that is the instruments necessary, the kind of project, and the promised date of completion for any project.

4. The system of claim 2, wherein an automated third-party scheduling application connects and schedules artists to artists found on the table/listing and restricted within a specific time, the last 45 days of any 90-day period of time.

5. The system of claim 2, wherein a third-party scheduling application connects and schedules artists with composer-clients for one hour time blocks during a limited period of time of 45 days, or the first 45 days of a 90-day period depending on the project the system is executing.

6. The system of claim 1 or claim 2, wherein a third-party storage application is connected to the system and automatically prompts, stores and shares project information, in this case sheet music files and audio files, between client-composers and artists and composers within the system's tables.

7. The system of claim 1 or claim 2, wherein a third-party storage application is connected to the system and automatically prompts and stores necessary contracts, copyright, and permissions between client composers and the system depending on the project.

8. The system of claim 1 or claim 2, wherein a third-party storage application is connected to the system and automatically prompts and shares completed recordings by said artists within the system with client-composers.
